(19) United States
(12) Patent Application Publication
(10) Pub. No.: US 2011/0244927 A1
(43) Pub. Date: Oct. 6, 2011

(54) Apparatus and Method for Wireless Headsets

(75) Inventors: Juhani Valdemar Kari, Lieto (FI); Petri Johannes Seppala, Halikko (FI); Heini Saari, Turku (FI); Olga Cherepenina, Salo (FI)

(73) Assignee: NOKIA CORPORATION, Espoo (FI)

(21) Appl. No.: 12/752,039

(22) Filed: Mar. 31, 2010

(51) Int. Cl. H04W 88/02

(52) U.S. Cl. 455/569.1; 455/575.2

(57) ABSTRACT

In accordance with an example embodiment of the present invention, an apparatus is provided, comprising: a wireless headset configured to detect removal of the wireless headset from a holder; and perform at least one of switching to a powered state, establishing a communication link with a mobile device, detecting a connection attempt and accepting the connection attempt when the removal is detected.

### TECHNICAL FIELD

The present application relates generally to wireless headsets.

### BACKGROUND

Wireless headsets are a class of accessory devices widely used with various portable electronic devices. Wireless headsets enable the user to access audio features of a portable device while the device itself may be stowed away and located at a distance from the user. Example applications of wireless headsets include having a telephone conversation while being engaged in another activity such as driving a car, or listening to music while the device is stowed in a bag or a pocket.

Wireless headset units may comprise audio transducers for capturing and reproducing sound waves, and they are configured for communication with other devices by various methods, such as short-range radio techniques, including as an example Bluetooth radio. Wireless headset units may also comprise input devices for controlling various features the unit, such as one or more buttons for switching the unit on or off, and receiving or ending a call. The units may be monaural or stereophonic, and they may be designed to be worn by the user on the ear, over the head, or in other suitable ways.

### SUMMARY

Various aspects of examples of the invention are set out in the claims.

According to a first aspect of the present invention, an apparatus is provided, comprising: a wireless headset configured to detect removal of the wireless headset from a holder; and perform at least one of switching to a powered state, establishing a communication link with a mobile device, detecting a connection attempt and accepting the connection attempt when the removal is detected.

According to a second aspect of the present invention, a method is provided, comprising: detecting removal of a wireless headset from a holder, and if said the removal is detected: switching the wireless headset to a powered state, establishing a communication link between the wireless headset and a mobile device, and detecting a connection attempt, and if a connection attempt is detected, accepting the connection attempt.

According to a third aspect of the present invention, an apparatus is provided, comprising: at least one processor; and at least one memory including computer program code the at least one memory and the computer program code configured to, with the at least one processor, cause the apparatus to perform at least the following: detecting removal of a wireless headset from a holder, and if the removal is detected: switching the wireless headset to a powered state, establishing a communication link between the wireless headset and a mobile device, and detecting a connection attempt, and if a connection attempt is detected, accepting the connection attempt.

### BRIEF DESCRIPTION OF THE DRAWINGS

For a more complete understanding of example embodiments of the present invention, reference is now made to the following descriptions taken in connection with the accompanying drawings in which:

FIG. 1 is a diagram illustrating a wireless headset according to an example embodiment of the invention;

FIG. 2 is a block diagram illustrating a wireless headset according to an example embodiment of the invention;

FIG. 3a is a diagram illustrating a wireless headset coupled with a holder and a mobile device according to an example embodiment of the invention;

FIG. 3b is a diagram illustrating a wireless headset such as in FIG. 3a uncoupled from a holder and a mobile device according to an example embodiment of the invention;

FIG. 4 is a diagram illustrating a holder configured to be installed in a vehicle according to an example embodiment of the invention;

FIG. 5 is a diagram illustrating a wearable holder configured to be worn by a user according to an example embodiment of the invention;

FIG. 6 is a flow diagram illustrating a method according to an example embodiment of the invention;

FIG. 7 is a flow diagram illustrating a method according to an example embodiment of the invention;

FIG. 8 is a flow diagram illustrating a method according to an example embodiment of the invention;

FIG. 9 is a flow diagram illustrating a method according to an example embodiment of the invention; and

FIG. 10 is a flow diagram illustrating a method according to an example embodiment of the invention.

### DETAILED DESCRIPTON OF THE DRAWINGS

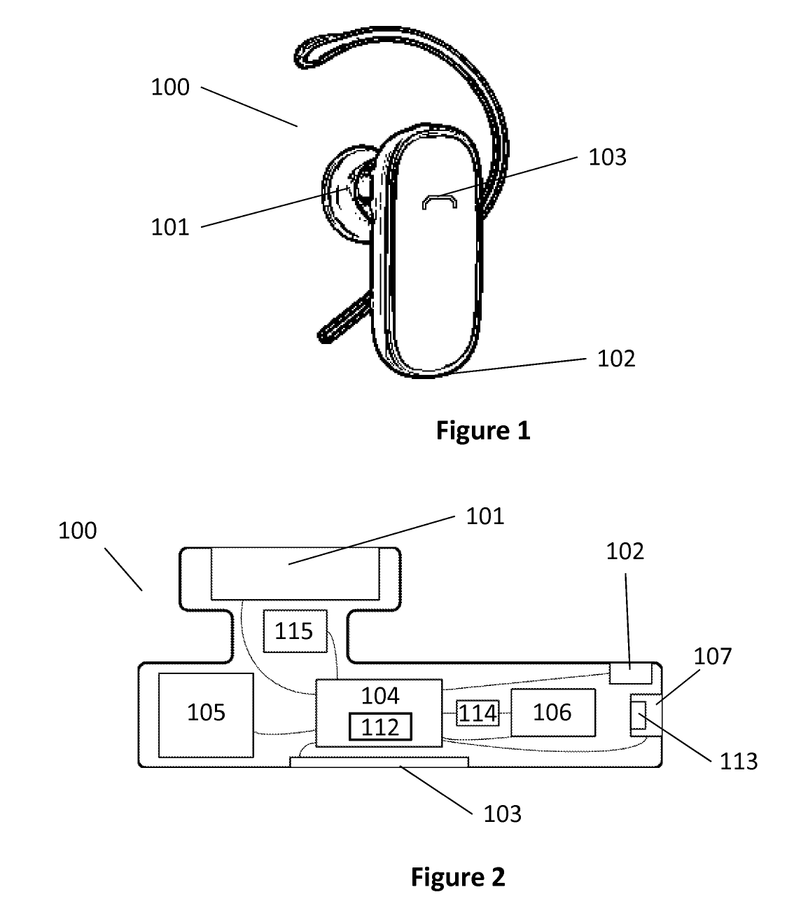

An example embodiment of the present invention and its potential advantages are understood by referring to FIG. 1 through 10 of the drawings.

FIG. 1 is a diagram illustrating a wireless headset 100 according to an example embodiment of the invention. A wireless headset 100 is communication device that may communicate wirelessly with a base device and may be worn proximate to head. Communication comprises audio signals, which may represent speech, music, or other types of audio transmissions. The wireless headset 100 comprises a loudspeaker element 101 and a microphone 102. The wireless headset 100 is generally configured to be worn by the user in such a way that an audio signal provided by the loudspeaker element 101 is audible for the user and the microphone 102 captures the voice of the user. In an embodiment, the loudspeaker element 101 is housed in a protruding part shaped to be received in the ear of the user. The microphone 102 may be housed in a part of the wireless headset 100, which may be proximate to the mouth of the user when the wireless headset 100 is being worn by the user. In an embodiment, the wireless headset 100 comprises a switch 103, which is configured to actuate, for example, power on/off state, accepting or terminating call, and/or other functions relating to the wireless headset 100. However, in some embodiments of the invention, the switch 103 is not present. In some embodiments, a plurality of switches and/or other input devices may be provided. In some embodiments, the switch 103 may be configured to be responsive to a long key press, which means that a predetermined delay time is allowed to lapse before an actuation signal is produced. It should be understood that many variations of mechanical design are possible without departure from the spirit of the invention. For example, the wireless headset 100 may be provided with various removable or extendable elements for improving ergonomics, such as an earloop part for supporting the wireless headset in its use position. While a monaural wireless headset 100 is illustrated in the drawing, a stereophonic headset may be provided without departing from the spirit of the invention.

FIG. 2 is a block diagram illustrating a wireless headset 100 according to an example embodiment of the invention. In an embodiment, the wireless headset 100 comprises at least one processor 104 and at least one memory 112 including computer program code. The at least one memory 112 and the computer program code are configured to, with the at least one processor 104, cause the apparatus to perform methods comprising embodiments of the invention. The at least one processor 104 may be operatively coupled to a loudspeaker element 101 and a microphone 102. In some embodiments, the at least one processor 104 may be coupled to a switch 103, which is configured to actuate, for example, power on/off state, accepting or terminating call, and/or other functions relating to the wireless headset 100. However, in some embodiments of the invention the switch 103 is not present. The wireless headset 100 further comprises a transceiver 105, such as a Bluetooth transceiver. The wireless headset 100 further comprises a power source, such as a battery 106. In an embodiment, the wireless headset 100 also comprises a mechanical interface 107, which in some embodiments comprises a charging interface for charging the battery 106. In an embodiment, the mechanical interface comprises a detection switch 113, which may be a mechanical, electrical, magnetic, or other type of switch. The detection switch 113 is configured to be actuated according to whether the wireless headset 100 is coupled with a holder, which will be described later.

In an embodiment, the wireless headset 100 may be configured to monitor the remaining charge level of the battery 106 and to detect a first battery charge level and a second battery charge level. In an embodiment, the second battery charge level is lower than the first battery charge level. The first battery charge level may correspond to a low charge level, in which the remaining charge is only sufficient to power the wireless headset 100 for a relatively short time. The second battery charge level may correspond to a substantially empty state, in which the remaining charge is no longer sufficient to maintain the wireless headset 100 in a powered state. For monitoring the battery charge level, the wireless headset 100 comprises in an embodiment a voltage monitoring element 114, which is connected with the battery 106 and the at least one processor 104 for monitoring the voltage of the battery 106.

In an embodiment, the wireless headset 100 comprises an alert element 115, which may be configured to provide alerts when the first battery charge level or the second battery charge level is detected. The alert element 115 may be configured to provide an audio alert, a haptic alert, a visual alert using a LED or a display, or any other suitable type of alert signal. However the loudspeaker element 101 may be used for providing alert signals. In an embodiment, the alert element 115 may not be present.

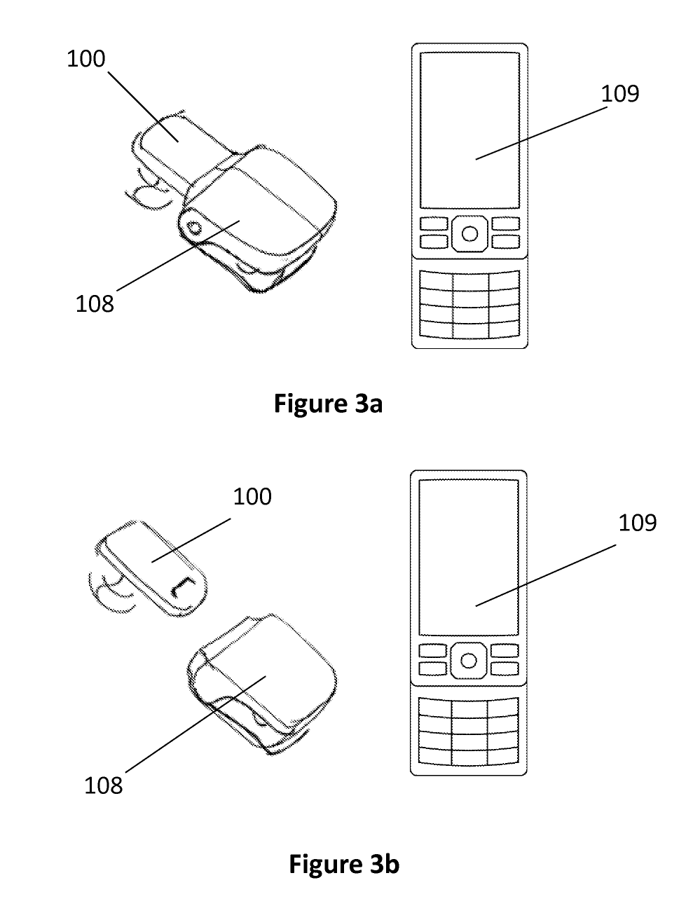

FIG. 3a is a diagram illustrating a wireless headset 100, coupled with a holder 108, and a mobile device 109 according to an example embodiment of the invention. According to FIG. 3a, the wireless headset 100 may be at least partially inserted inside the holder 108.

FIG. 3b is a diagram illustrating a wireless headset 100 such as in FIG. 3a, uncoupled from a holder 108, and a mobile device 109 according to an example embodiment of the invention. According to FIG. 3b, the wireless headset 100 is not in mechanical contact with the holder 108. Also illustrated in the drawing is a mobile device 109. The wireless headset 100 and the mobile device 109 may be configured to communicate wirelessly with each other. While the mobile device 109 is illustrated as a mobile telephone, the mobile device 109 may be a portable computer, multimedia device, gaming device, navigation device, electronic document reading device, and/or any other electronic devices with audio capabilities.

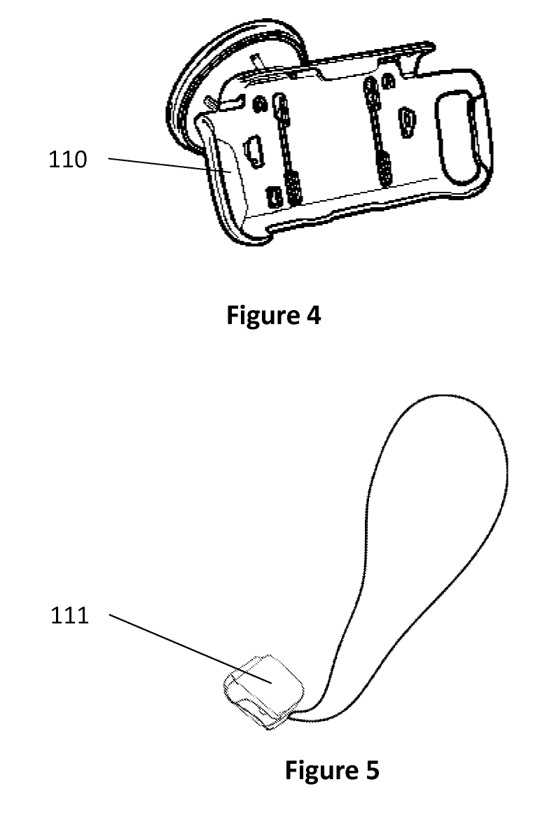

FIG. 4 is a diagram illustrating a holder 110 configured to be installed in a vehicle, according to an example embodiment of the invention. The holder 110 may be configured to be installed on the dashboard or on the windshield of a motor vehicle such as a car.

FIG. 5 is a diagram illustrating a wearable holder 111 configured to be worn by a user according to an example embodiment of the invention. The wearable holder 111 may be configured to be worn by the user for example hung around the neck, or attached to a pocket, or a belt. However, other types of holders 108, not shown in the drawings, are possible. These may include desktop cradles, charging stations, and/or the like configured to provide a storage or holding solution, mechanical protection, battery charging, additional functions, and/or otherwise improve usability and/or value of the device.

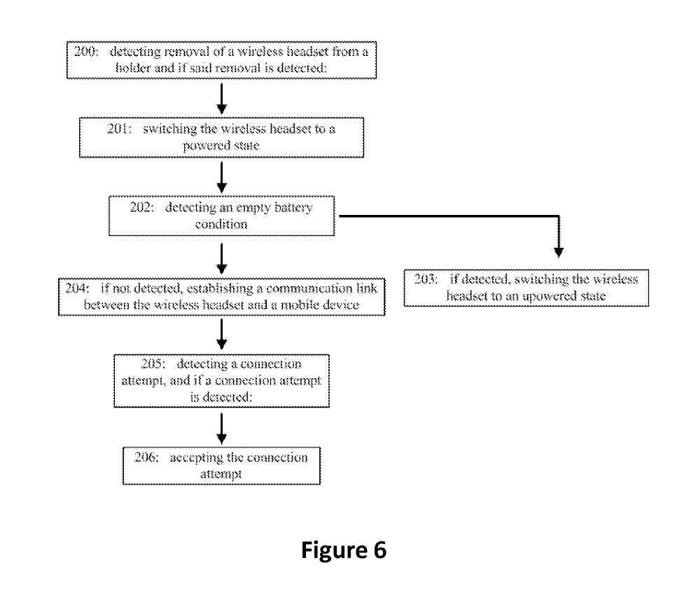

FIG. 6 is a flow diagram illustrating a method according to an example embodiment of the invention. Consider the wireless headset 100 of FIG. 1 in an unpowered state. In this state the transceiver 105 of FIG. 2, the processor 104 of FIG. 2, and other elements comprised in the wireless headset 100 may be in a non-operating state. In an embodiment, no communication link exists with other devices. In an embodiment, substantially no current is being drawn from the battery 106 of FIG. 2. The unpowered state may correspond to the state illustrated in FIG. 3a, where the wireless headset 100 is coupled with the holder 108. At 200, if the wireless headset 100 is removed from the holder 108, an actuation of the mechanical interface 107 of FIG. 2 occurs. At 201, the actuation causes the wireless headset 100 to switch to a powered state. In the powered state, the transceiver 105, the processor 104, and other elements comprised in the wireless headset 100 may be in an operating state, powered by the battery 106. At 202, the charge level of the battery 106 is checked, and if an empty battery condition is detected, the wireless communication headset 100 is switched to an unpowered state at 203. If an empty battery condition is not detected, establishing a communication link with another device is attempted at 204. In an embodiment, the communication link may be a Bluetooth connection. In an embodiment, the other device is the mobile device 109 of FIG. 3a or 3b. After a communication link has been sufficiently established, a connection attempt from the mobile device 109 may be detected at 205, and if such connection call is detected, it is automatically accepted at 206. In an embodiment, the connection attempt is a phone call received by the mobile device 109. In this embodiment, accepting the connection attempt at 206 results in the wireless headset 100 being in an active call state, in which audio signals from a remote user are relayed to the loudspeaker element 101 of FIG. 1, and speech of a local user is captured by the microphone 102 of FIG. 2. If no call is accepted, the wireless headset 100 may be in a powered state without a connection in progress. If no communication link with another device has been established, the wireless headset 100 may be in a powered state in which the wireless headset 100 is receptive for pairing requests from other devices.

In an embodiment, the wireless headset 100 is further configured to be capable of establishing a further communication link with a different device when at least one communication link is already active. In an embodiment, the wireless headset 100 is further configured to be capable of accepting a further call when at least one call is already active. As an example, the user may be provided with a possibility of placing a first call on hold while answering a second call.

In an embodiment, the connection attempt is a stream of audio such as music being played by a media player comprised in the mobile device 109. In an embodiment, accepting the connection attempt results in the wireless headset 100 being in an active state in which the audio stream is reproduced using the loudspeaker element 101.

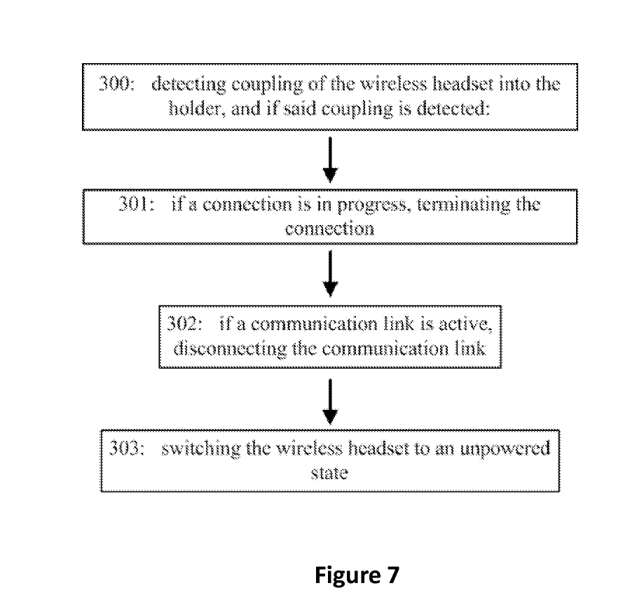

FIG. 7 is a flow diagram illustrating a method according to an example embodiment of the invention. Consider the wireless headset 100 of FIG. 1 in a powered state. In this state, the transceiver 105 of FIG. 2, the processor 104 of FIG. 2, and other elements comprised in the wireless headset 100 may be in an operating state, a communication link may exists with other devices, and the wireless headset 100 may be powered by the battery 106 of FIG. 2. In an embodiment, the communication link may be a Bluetooth connection. Further, an active connection may be in progress. In an embodiment, the connection is a phone call. In an embodiment, the connection is a stream of audio such as music being played by a media player. The powered state may correspond to the state illustrated in FIG. 3b, where the wireless headset 100 is coupled with the holder 108. At 300, if the wireless headset 100 is coupled with the holder, this results in an actuation of the mechanical interface 107 of FIG. 2. At 301, this causes a possible active connection to be terminated. In an embodiment, all active connections are terminated. In an embodiment, termination of an active connection may mean terminating an active call, rejecting an incoming call, or cancelling an outgoing call attempt. The communication link between the wireless headset 100 and the mobile device 109 of FIG. 3a or 3b is disconnected at 302. The wireless headset 100 is switched to an unpowered state at 303.

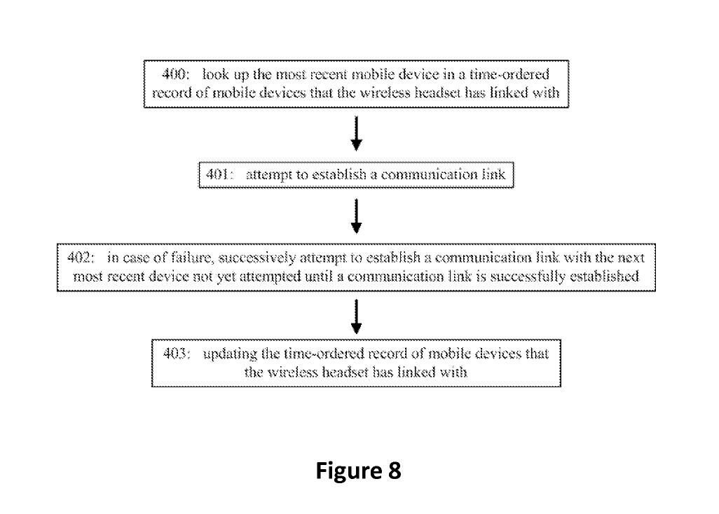

FIG. 8 is a flow diagram illustrating a method according to an example embodiment of the invention. In an embodiment, the wireless headset 100 of FIG. 1 attempts to establish a communication link with another device, which may be the mobile device 109 of FIG. 3a or 3b. This may be carried out using information stored in a list of recently used devices in the memory 112 of FIG. 2. The list may contain identification information about mobile devices that the wireless headset 100 has recently linked with. In an embodiment, the list is time-ordered, for example, in a reverse order in such a way that the most recently used device is listed first, followed by the second last used, and continuing similarly in reverse temporal order with any further devices. At 400, if the list is non-empty, the wireless headset 100 looks up the most recently used device on the list. At 401, the wireless headset 100 attempts to establish a communication link with the device. At 402, in case of failure, the next most recently used device not yet attempted is looked up from the list and establishing a communication link with it is attempted. This is continued until either a communication link has been successfully established, or the list of devices is exhausted. As a result, the wireless headset 100 is in a powered state in which a communication link with another device may exist. The time-ordered record of devices that the wireless headset 100 has linked with is updated accordingly at 403. In this state, the wireless headset 100 may be receptive for establishing a communication link with a device not found on the list of recently used devices. If a communication link with another device has been successfully established, the wireless headset 100 detects whether an incoming call attempt is being received by the mobile device 109. If no such call is detected, the wireless headset 100 remains in a powered no call state.

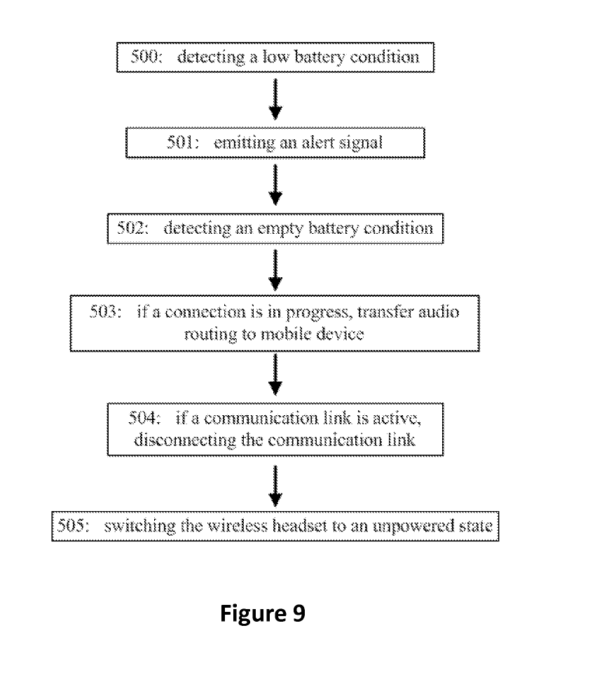

FIG. 9 is a flow diagram illustrating a method according to an example embodiment of the invention. In an embodiment, the wireless headset 100 of FIG. 1 is configured to monitor the charge level of the battery 106 of FIG. 2 comprised in the wireless headset 100. Monitoring may be done using the voltage monitoring element 114 of FIG. 2 comprised in the wireless headset 100. At 500, it is detected that the charge level of the battery 106 is at or below a first battery charge level, which may correspond to a low charge level. If this is detected, the wireless communication device 100 is considered to be in a low charge state. At 501 the wireless communication device 100 may emit an alert signal to inform the user of a low charge state. In an embodiment, the alert signal may be an audio signal, such as a beep, reproduced using the loudspeaker element 101 of FIG. 1. However, other types of alert signals, such as haptic or visual signals, and combinations of different alert signals, are possible. The alert signal may be given using the alert element 115 of FIG. 2 comprised in the wireless headset 100. The alert signal may be emitted once when the first battery charge level is detected, or repeatedly for as long as the wireless headset 100 remains powered and the battery charge level remains below the first battery charge level. If it is detected that the wireless headset 100, when being in a powered state, has been coupled with the holder 108 of FIG. 3a or 3b, a possible active connection is terminated, a communication link with another device is disconnected and the wireless headset 100 is switched to an unpowered state, such as in FIG. 7. These operations are carried out independently of whether an alert signal has been previously emitted.

At 502, the charge level of the battery 106 is determined to be at or below a second battery charge level. In an embodiment, a secondary battery charge level corresponds to a substantially empty charge level. At 503 a possible active connection is transferred to be handled by the mobile device 109. In an embodiment, the connection is a phone call. In this embodiment, transfer of the active connection comprises routing audio signals from a remote user to be reproduced using a loudspeaker element in the mobile device, and speech of a local user to be captured by a microphone in the mobile device. In an embodiment, the connection may be a stream of audio such as music being played by a media player. In this embodiment, transfer of the active connection comprises routing audio signals from a media player comprised in the mobile device 109 of FIG. 3a or 3b to be reproduced by the loudspeaker element 101 comprised in the mobile device 109. If a communication link with the mobile device 109 is active, the communication link is disconnected at 504. At 505, the wireless headset 100 is switched to an unpowered state, even if it remains uncoupled from the holder 108.

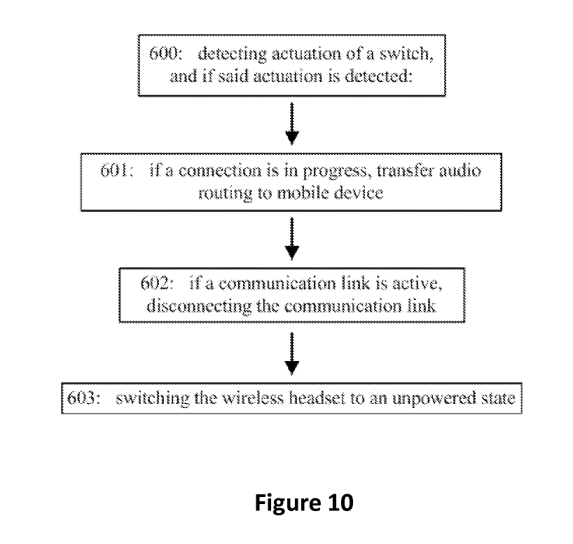

FIG. 10 is a flow diagram illustrating a method according to an example embodiment of the invention. In an embodiment, the wireless headset 100 of FIG. 1 comprises the switch 103 of FIG. 1. At 600, actuation of the switch 103 in a powered state of the wireless headset 100 is detected. At 601, if a connection is in progress, audio routing is transferred to the mobile device 109. In an embodiment, the connection may be a phone call. In an embodiment, transfer of the active connection comprises routing audio signals from a remote user to be reproduced using a loudspeaker element in the mobile device, and speech of a local user to be captured by a microphone in the mobile device. In an embodiment, the connection is a stream of audio such as music being played by a media player. In an embodiment, transfer of the active connection comprises routing audio signals from a media player comprised in the mobile device 109 of FIG. 3a or 3b to be reproduced by a loudspeaker element comprised in the mobile device 109. A possible communication link with the mobile device 109 is disconnected at 602, and the wireless headset 100 is switched to an unpowered state at 603 even if it remains uncoupled from the holder 108 of FIG. 3a or 3b. After a possible subsequent coupling of the wireless headset 100 into a holder 108, the wireless headset 100 remains in an unpowered state.

Without in any way limiting the scope, interpretation, or application of the claims appearing below, a technical effect of one or more of the example embodiments disclosed herein is to provide a wireless headset configured to cooperate with a holder and a mobile device. Another technical effect of one or more of the example embodiments disclosed herein is that removal of the wireless headset from the holder causes the wireless headset to undergo a transition from an unpowered state to an active call state, without a need to perform other actuation or configuration actions. Another technical effect of one or more of the example embodiments disclosed herein is that the wireless headset can be activated and connected to a mobile device by removing it from the holder. Another technical effect of one or more of the example embodiments disclosed herein is that a user can accept an incoming phone call by removing the wireless headset from the holder. Another technical effect of one or more of thee example embodiments disclosed herein is that a user can route an audio signal such as music played by a media player in a mobile device to be reproduced by a loudspeaker element in the wireless headset. Another technical effect of one or more of the example embodiments disclosed herein is that placing the wireless headset in the holder causes a possible call or reproduction of music by the headset to be terminated, a possible communication link with another device to be disconnected, and the wireless headset to be switched to an unpowered state. Another technical effect of one or more of the example embodiments disclosed herein is that actuation of a switch provided in the wireless headset can be used to transfer audio routing of an active call from the wireless headset to another device. Another technical effect of one or more of the example embodiments disclosed herein is that actuation of a switch provided in the wireless headset can be used to disconnect a communication link with another device and to switch the wireless headset to an unpowered state. Another technical effect of one or more of the example embodiments disclosed herein is that a carrying solution is provided for wireless headsets. Another technical effect of one or more of the example embodiments disclosed herein is that a charging solution is provided.

Embodiments of the present invention may be implemented in software, hardware, application logic or a combination of software, hardware and application logic. The software, application logic and/or hardware may reside on the wireless communication device 100. If desired, part of the software, application logic and/or hardware may reside on the mobile device 109. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a wireless headset configured to
detect removal of the wireless headset from a holder; and
perform at least one of switching to a powered state, establishing a communication link with a mobile device, detecting a connection attempt and accepting the connection attempt when the removal is detected.

2. An apparatus as in claim 1, wherein the wireless headset is further configured to detect a coupling of the wireless headset with the holder and perform at least one of terminating a connection, disconnecting a communication link, and switching the wireless headset to an unpowered state when the coupling is detected.

3. An apparatus as in claim 1, the apparatus further comprising a battery having a charge level, wherein the apparatus is configured to detect a first battery charge level and a second battery charge level, the second battery charge level being lower than the first battery charge level.

4. An apparatus as in claim 3, wherein the apparatus is configured to emit an alert signal when the first battery charge level is detected.

5. An apparatus as in claim 3, wherein the apparatus is configured to cause transfer of audio routing to the mobile device when the second battery charge level is detected.

6. An apparatus as in claim 1, wherein the apparatus further comprises a switchwherein the switch is configured to cause termination of a call if a call is in progress when the switch is actuated.

7. An apparatus as in claim 6, wherein the switch is configured to cause switching the apparatus to an unpowered state if a call is not in progress when the switch is actuated.

8. An apparatus as in claim 6, wherein the switch is configured to cause a connection attempt to be accepted when the switch is actuated.

9. An apparatus as in claim 1, wherein the holder is configured to be installed in a vehicle.

10. An apparatus as in claim 1, wherein the holder comprises a charging interface for charging a battery comprised in the wireless headset.

11. An apparatus as in claim 1, wherein the holder is configured to be worn by a user.

12. An apparatus as in claim 1, wherein the apparatus further comprises a Bluetooth transceiver.

13. An apparatus as in claim 1, wherein the mobile device is a mobile telephone.

14. A method, comprising:
detecting removal of a wireless headset from a holder, and if the removal is detected:
switching the wireless headset to a powered state,
establishing a communication link between the wireless headset and a mobile device, and detecting a connection attempt, and if a connection attempt is detected, accepting the connection attempt.

15. A method as in claim 14, comprising:
detecting coupling of the wireless headset with the holder, and if the coupling is detected, perform at least one of terminating a connection, disconnecting a communication link, and switching the wireless headset to an unpowered state.

16. A method as in claim 14, wherein the wireless headset is configured to maintain a time-ordered record of communication links to mobile devices.

17. A method as in claim 16, wherein the establishing a communication link is first attempted with the most recent mobile device in the time-ordered record, and in case of failure, the communication link is reattempted with a next most recent device.

18. A method as in claim 14, wherein the mobile device is a mobile telephone.

19. An apparatus, comprising:
at least one processor; and
at least one memory including computer program code the at least one memory and the computer program code configured to, with the at least one processor, cause the apparatus to perform at least the following:
detecting removal of a wireless headset from a holder, and if the removal is detected:
switching the wireless headset to a powered state, establishing a communication link between the wireless headset and a mobile device, and detecting a connection attempt, and if a connection attempt is detected, accepting the connection attempt.

20. An apparatus as in claim 19, wherein the apparatus is further configured to, with the at least one processor, cause the apparatus to perform at least the following:
detecting coupling of the wireless headset with the holder, and if the coupling is detected:
if a connection is in progress, terminating the connection, disconnecting the communication link, and
switching the wireless headset to an unpowered state.
